(19) United States
(12) Patent Application Publication
(10) Pub. No.: US 2005/0167612 A1
(43) Pub. Date: Aug. 4, 2005

(54) Passive fluorescent cooling

(76) Inventor: Aubrey Jaffer, Bedford, MA (US)

Correspondence Address: AUBREY JAFFER, 33 BUEHLER ROAD, BEDFORD, MA, 01730, US

(21) Appl. No.: 10/769,710

(22) Filed: Feb. 2, 2004

(51) Int. Cl. G01T 1/10

(52) U.S. Cl. 250/458.1

(57) ABSTRACT

The combination of an infrared phosphor fluorescing at wavelengths between 8 μm and 13 μm with a wavelength-selective cold mirror glazing transparent to the fluoresced radiation can create a device capable of providing passive radiative cooling in tropical heat and humidity in locations with an unobstructed view of sky. The concentration of thermal radiative energy into the narrow band radiated by the phosphor, and the reflection of infrared radiation outside that band, provides more net cooling through saturation humidity at 37° C. than does a black-body or conventional selective radiator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to passive radiative cooling of buildings and enclosures in humid environments.

The mechanism of passive radiative cooling has long been known, but always with the restriction to arid locales.

The spectral atmospheric window through which the thermally generated radiation can pass reduces to 50% transparency in conditions of saturated humidity at 37° C. Although the peak of black-body emission lies in this 8 μm to 13 μm band, the majority of the emission falls outside this band into bands in which the atmosphere is opaque and emissive.

Thus in hot and humid conditions a black-body radiator receives nearly as much incoming thermal radiation as it emits, reducing its cooling capacity severely. When the heating effects of solar radiation (daylight) are taken into account, black-body radiators cease cooling.

U.S. Pat. No. 3,043,112 issued Jul. 10, 1962 to A. K. Head calculates cooling ability for cloudless and cloudy skies, assuming that the clouds' surface temperature is 0° C. Cirrus clouds composed of ice crystals would be at or below freezing. Lower clouds can be much warmer, limiting the cooling available. And in humid tropical conditions infrared absorption occurs close to the ground, rendering black-body cooling ineffective.

U.S. Pat. No. 3,310,102 issued Mar. 21, 1967 to F. Trombe uses polyvinyl chloride as a selective radiator. The devices described face north to avoid direct solar radiation; a configuration which will not be beneficial near the earth's equator. Trombe's December measurements at Montlouis, Pyrenees-Orientales, France on clear days at temperatures near freezing have little relevance to humid tropical regions.

In their paper “Radiative Cooling to Low Temperatures: General Considerations & Application to Selectively Emitting SiO Films”, Journal of Applied Physics Vol 52(6) June 1981, pp. 4205-4220, C. G. Granqvist and A. Hjortsberg give a thorough analysis of their SiO selective radiator, but manifest no ambitions to provide cooling in humid atmospheres.

U.S. Pat. No. 4,586,350 issued May 1986 to Berdahl et al gives theoretical cooling rates assuming a “clear dry climate”.

U.S. Pat. No. 4,624,113 issued November 1986 to Hull et al combines non-imaging optical concentrators with selective emitters. This combination does not alter the incoming-outgoing radiation balance responsible for poor performance in high humidity.

U.S. Pat. No. 5,405,680 issued April 1995 to Chang et al is another selective radiator. FIG. 2 of their patent shows the ideal radiator having emissivity 1.0 from 8 μm to 13 μm; whereas the phosphor of the present invention has an emissivity peak effectively greater than 1.0.

U.S. Pat. No. 4,323,619 issued April 1982 to Silvestrini et al discloses that high-density polyethylene (HDPE) is 70% transparent from 8 μm to 13 μm while loaded with enough white pigment to achieve 70% solar reflectance. They bond black HDPE film to the back of white HDPE. The carbon black particles are smaller than 5 μm, apparently radiating poorly at wavelengths longer than 5 μm. While it may cool adequately in dry climates, simulations of 70% infrared transmittance in high humidity show marginal performance.

In hot, humid regions practical passive radiative cooling devices which operate both day and night require the simultaneous satisfaction of several constraints:
the device must reject nearly all the solar radiation falling on it;
the device must passively emit the bulk of its thermal energy at wavelengths between 8/Lm and 13 μm, an infrared atmospheric window which is roughly 50% transparent through saturated humidity at 37° C. at sea-level;
its glazing must be either vertically oriented and shielded or rugged enough to be cleaned of dust, bird droppings, and debris; or the glazing must be inexpensive and easily replaceable;
ultraviolet light must be prevented from degrading polyethylene glazing; and
the device should provide enough insulation between the radiator and its glazing so that condensation does not form on its glazing, as water's infrared absorption interferes with radiative cooling.

Another important aspect overlooked by some of the cited designs is that any materials visible to the emitter have the potential to radiate heat into the emitter if they are absorbent to infrared radiation.

### BRIEF SUMMARY OF THE INVENTION

The invention which enables passive radiative cooling in tropical regions is the use of an infrared phosphor which absorbs black-body radiation and fluoresces at wavelengths within the 8 μm to 13 μm infrared atmospheric window.

The phosphor converts shorter wavelength black-body emissions, which would otherwise not penetrate the atmosphere, into photons with wavelengths which radiate well, thus exceeding the cooling power of a selective black-body emitter.

In order for this gain to not be lost to infrared radiation flowing back into the device, the passband of transmission is narrowed around the phosphor wavelength by controlling the phosphor thickness, by applying optical coatings to the phosphor, or by interposing wavelength selective elements between the phosphor and the sky.

Addressing the need for protecting the polyethylene glazing from ultraviolet damage is a design for a cold mirror glazing consisting of a high-density polyethylene sheet with a sputtered aluminum coating which reflects solar irradiance (including ultraviolet), while transmitting the fluoresced infrared radiation.

### BRIEF DESCRIPTION OF THE SEVERAL VIEWS OF THE DRAWING

FIG. 1 is a cross-sectional view of an embodiment of the fluorescent radiative cooling device.

When the top surface is exposed to unobstructed sky the bottom surface becomes cooled.

FIG. 2 is a cross-sectional view of an embodiment of the fluorescent radiative cooling device mounted vertically with an infrared reflector redirecting its view toward the sky.

FIG. 3 is a cross-sectional view of an embodiment of the fluorescent radiative cooling device illustrating two methods to restrict the field of view of the emitter: inclined reflectors along the top edges; and internal double-sided corner reflectors.

FIG. 4 is a cross-sectional view of an embodiment of the fluorescent radiative cooling device using a ventilated solar-reflecting film.

### DETAILED DESCRIPTION OF THE INVENTION

A semiconductor with high carrier recombination rate, and having a bandgap energy between 0.100 eV and 0.119 eV, would absorb photons with energies larger than its bandgap and re-radiate most of their energy as photons having its bandgap energy.

In “HgCdTe infrared detectors”, OPTO-ELECTRONICS REVIEW 10(3), 159-174 (2002), P. Norton states “Since the bandgap of HgTe is negative, or inverted, the alloy can be grown to achieve arbitrarily small bandgaps.” This property makes HgCdTe and PbSnTe alloys well suited for the manufacture of thermal imaging detectors.

This article also reveals that with an anti-reflection coating, HgCdTe has a quantum efficiency greater than 90%. Because of the principle of detailed balance, a semiconductor which can absorb photons with 90% efficiency in equilibrium must also be able to emit photons efficiently. Therefore, HgCdTe can be a highly emissive phosphor.

With the ratio between CdTe and HgTe equal to 0.170±0.002, the wavelength of photons of bandgap energy stays within the 10.4 μm to 12.4 μm window over a temperature range of 273° K to 310° K. Because the bandgap's temperature dependence parallels the peak wavelength of blackbody emission, a single alloy radiates well from 273° K to 310° K.

Narrowing the transmission range of wavelengths around this 10.4 μm to 12.4 μm band results in a device which reflects most black-body radiation, giving it the ability to cool even though the worst-case atmospheric transmission in this band is only 50%.

Controlling the phosphor thickness or applying optical coatings to the phosphor can give adequate selectivity near 11 μm. But achieving the simultaneous rejection of solar irradiance requires selection by some other optical component.

According to “Optical Properties of Thin Solid Films”, Dover Publications, 1991 by O. S. Heavens, the sputtering of metals tends to deposit granular films. These films have high refractive index with lower absorption than electrically conductive metal films.

Computer simulation using matrices of Fresnel coefficients and the Maxwell-Garnett theory (from Heavens) shows that a single 20 nm thick layer of 90% granular aluminum embedded in 10% aluminum oxide deposited on a 14 μm thick HDPE sheet reflects 84% of solar irradiance, while transmitting 78% of the fluoresced infrared radiation. Sputtering aluminum onto HDPE in an oxygen atmosphere may produce such a layer.

In “Passive Cooling”, edited by Jeffrey Cook, MIT Press, 1989, Marlo Martin writes “Unfortunately, almost all known materials having adequate mechanical strength and chemical stability, including glass, are opaque over this [8 μm to 13 μm] spectra range.”

Worse still, many of those materials are absorbent in that range. The non-optical elements must be carefully designed to avoid flooding the phosphor with their black-body emissions.

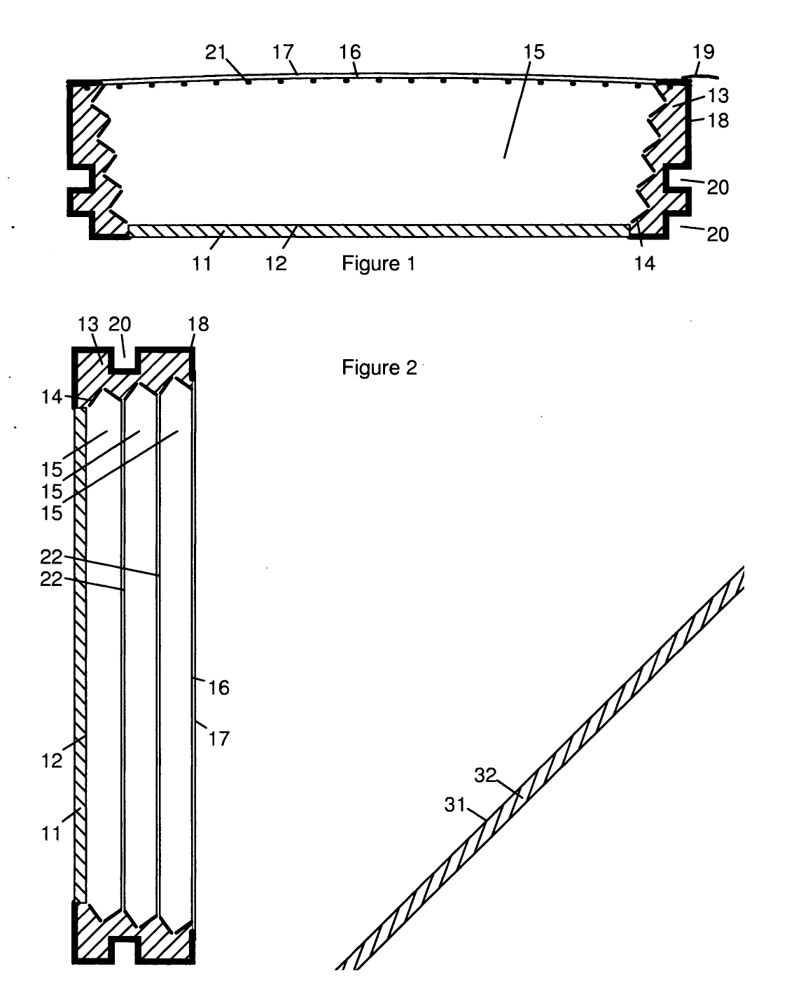

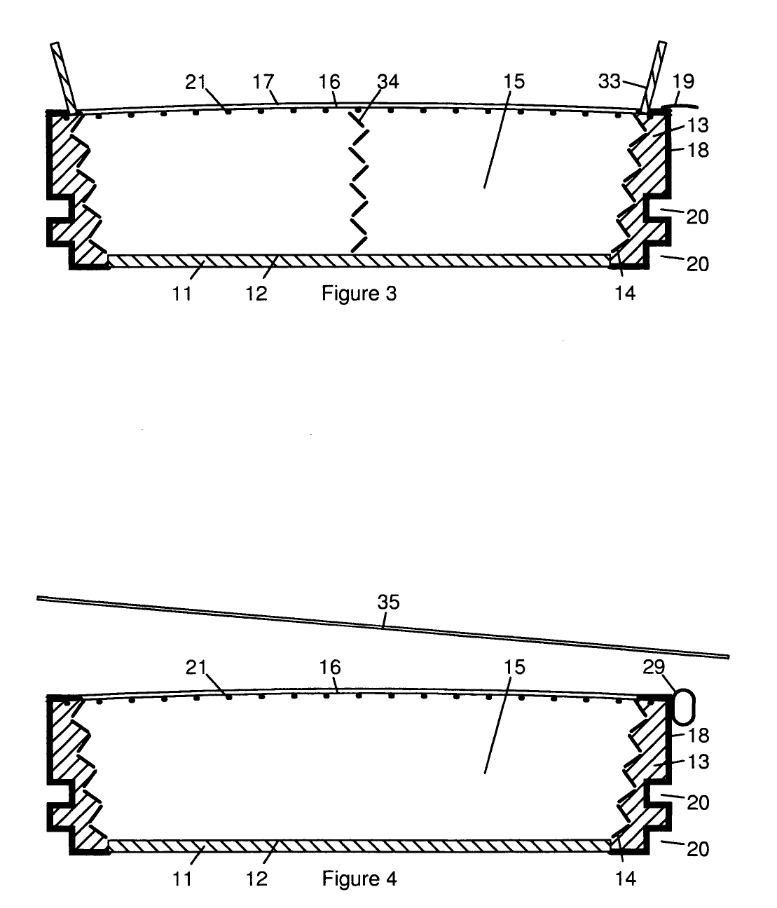

To that end, elements 14 of FIG. 1 are corner reflectors constructed of infrared-reflective strips such as aluminum sheet or specular aluminum deposited on glass or plastic. Corner reflectors return incident rays in a plane parallel to their original direction. With corner reflectors surrounding the optical chamber 15, it will not be exposed to the emissions of structural elements 13; and the view of the emitter will be narrowed, avoiding the higher airmass near the horizon with its higher absorption.

The thermal conductivity of elements 14 might limit the temperature difference attainable between the glazing 16 and the base 11. But with the corner reflectors supported by rigid insulating foam 13, they need not touch one another.

Other elements in FIG. 1 are the glazing, 16; the 20 nm granular aluminum layer, 17; the phosphor layer, 12; and the thermally conductive base, 11. A semiconductor phosphor can be deposited over an infrared emissive surface; or over a reflective one, in which case the phosphor will fluoresce from conducted phonons instead of thermal photons.

Element 21 is a coarse mesh screen supporting the glazing 16. The screen is formed with a slight crown at its center, which serves to prevent rainwater from pooling on the glazing.

The gas in the optical chamber of the horizontal radiator in FIG. 1 is cooled on the bottom. Thus convection will not transfer significant heat through the gas from the warmer glazing above it. The thermal conductivity of stationary nitrogen gas is 0.024 W/(m·K). The conduction through 10 cm of gas (0.24 W/(m²·K)) at a 30° K temperature difference would be only 7.2 W/m².

During times when the horizontal emitter plate is warmer than the glazing, air in the chamber will convect, increasing its cooling power.

Several expanded and cellular plastics have heat conductivities close to that of nitrogen gas. A rigid variety of such a plastic can be used for the side elements 13 in FIG. 1. The outer shell 18 of the device should be formed of a weatherproof material such as polyvinyl chloride. Elements 20 are

1. A radiative cooling device comprising:
an infrared phosphor emitter fluorescing at wavelengths for which the atmosphere is relatively transparent, such as between 8 μm and 13 μm; and,
interposed between said emitter and the sky, a glazing or glazings transparent to the fluoresced infrared radiation,
whereby the combination of said emitter and glazings transmit the narrow band of fluoresced infrared radiation toward the sky while preventing most infrared radiation in the broader band from the sky from being absorbed by the emitter, thus enabling the net cooling produced to exceed that achieved by radiators employing black-body or conventional selective emitters under humid conditions.

2. The apparatus of claim 1 wherein the glazings are wavelength-selective, reflecting most of direct and indirect solar radiation incident upon them, allowing the device to provide cooling in daylight.

3. The apparatus of claim 2 wherein the face of an infrared-transparent glazing is coated with a thin granular, non-conductive layer of metal to selectively reflect solar radiation while transmitting infrared radiation.

4. The apparatus of claim 2 wherein a glazing is absorbing of solar radiation, but transparent to the fluoresced infrared wavelengths; thus preventing the solar radiation which penetrates the solar-reflecting layer from reaching the phosphor.

5. The apparatus of claim 2 wherein a glazing is a solar screen described by Silvestrini et al in U.S. Pat. No. 4,323,619.

6. The combination of the apparatus of claim 1 with curved or flat reflectors, whereby the apparatus situated in a position which has a limited view of sky has its infrared field of view reflected skyward.

7. The apparatus of claim 6 wherein said reflectors reflect infrared radiation but are transparent to solar radiation.

8. The combination of the apparatus of claim 2 with curved or flat reflectors, whereby the apparatus situated in a position which has a limited view of sky has its infrared field of view reflected skyward.

9. The apparatus of claim 8 wherein said reflectors reflect infrared radiation but are transparent to solar radiation.

10. The combination of the apparatus of claim 1 with inclined reflectors along the top edges which restrict the field of view of the emitter to exclude horizons and obstructions.

11. The apparatus of claim 10 wherein said inclined reflectors reflect infrared radiation but are transparent to solar radiation.

12. The combination of the apparatus of claim 2 with inclined reflectors along the top edges which restrict the field of view of the emitter to exclude horizons and obstructions.

13. The apparatus of claim 12 wherein said inclined reflectors reflect infrared radiation but are transparent to solar radiation.
